(19) United States
(12) Patent Application Publication
(10) Pub. No.: US 2024/0286472 A1
(43) Pub. Date: Aug. 29, 2024

(54) Retractable Roof System

(71) Applicant: Brett Dicus, Boonville, MO (US)

(72) Inventor: Brett Dicus, Boonville, MO (US)

(21) Appl. No.: 18/586,275

(22) Filed: Feb. 23, 2024

Related U.S. Application Data
(60) Provisional application No. 63/447,690, filed on Feb. 23, 2023.

(51) Int. Cl. B60J 7/14; B60J 1/18

(52) U.S. Cl. CPC B60J 7/146; B60J 1/1823

(57) ABSTRACT

The present invention provides retractable roof systems for vehicles that have an occupant space for one or more individuals. Advantageously, these systems can be operated with one hand by an occupant in a vehicle without the need for an external power source.

### FIELD OF THE INVENTION

The present invention relates to retractable roof systems for vehicles, and their methods of use and manufacture.

### BACKGROUND OF THE INVENTION

All-terrain vehicles (ATVs), golf carts, and utility vehicles are popular well-known vehicles. These vehicles may include a roof or other cover over the passenger area. These roofs may be fixed, retractable, or otherwise moveable. They often use an external power source to open or close. Some are more quickly and easily operated than others. When not in use, storage can be difficult for some designs.

### SUMMARY OF THE INVENTION

The present invention provides a new design and system for a retractable roof system that is particularly suitable for use on ATVs, golf carts, and utility vehicles. Advantageously, systems of the present invention may be installed in either new vehicles or retrofitted to existing vehicles. Retractable covers of the invention do not require a power source to operate. Rather, these covers are manually operated with one hand by an occupant inside the vehicle. Another advantage of the present invention is that the cover is a hardtop that may be opaque or preferably transparent.

In particular, the invention provides a retractable roof system for a vehicle having an occupant space for one or more individuals. The system comprises a cover, a frame, two buttresses, a cover support, and a handle that is positioned over the occupant space for one or more individuals in a vehicle.

The cover has a top, a bottom, a front, a back, and two lateral sides. The cover is positioned over the occupant space and is configured to be moved between an open position and a closed position over the occupant space. Preferably, the retractable roof system comprises a cover that is a hardtop and is opaque, transparent, or a combination thereof. Those of skill in the art will recognize that the cover can be composed of a variety of suitable materials. For example, the cover may be composed of polycarbonates, glass, or a combination thereof.

The frame has a front, a back, two sides (i.e. a first side and a second side), and is coupled to the vehicle. The frame may be made from a variety of materials that provide sufficient strength and rigidity to function in the invention.

The invention also includes two buttresses (i.e. a first buttress and a second buttress). Each buttress comprises at least one extension and a horizontal member. A first end of each extension is coupled to the adjacent side of the frame, and a second end of each extension is coupled to the adjacent horizontal member of the same buttress. Each horizontal member, in turn, is coupled to the bottom of the cover. In preferred embodiments, each buttress includes two extensions. Those of skill in the art will recognize that the buttresses can be constructed from a wide variety of materials. The materials used to construct the buttresses need only be of sufficient strength and rigidity to support the cover and allow the invention to operate as intended.

The cover support of the invention comprises a rotatable rod, two arms, and two slide tubes. Each end of the rotatable rod is attached near or at the top of the adjacent arm of the cover support. Each slide tube is attached near or at the base of the adjacent arm. Those of skill in the art will recognize that the rotatable rod and slide tubes can be attached to the arms of the cover support through a variety of suitable means. When the cover is moved between the open and closed positions it is only necessary that the means of attaching the rod to the arms allows the rod to rotate as needed. In addition, skilled artisans will recognize that the cover support can have a variety of shapes and function as needed in the invention. For example, the rod may be polyhedral or cylindrical.

The invention includes a mounting bracket that has a front section and two side sections. Each side section extends from the adjacent end of the front section. In a preferred embodiment, each side section is coupled to the vehicle and the cover support by one or more fasteners. Those of skill in the art will recognize that the mounting bracket can have a wide variety of shapes and still function as needed in the invention. For example, in an alternative embodiment rather than the side sections, the front section of the mounting bracket is coupled directly to the vehicle.

The invention also includes a handle. In preferred embodiments, the handle has a base and two prongs. Those of skill in the art will recognize that the handle can have alternative configurations and still function as intended in the invention. In preferred embodiments, each prong extends from the adjacent end of the base of the handle. The base and prongs of the handle may be separate pieces, or preferably, formed from a single piece. A preferred shape for handle is a U-shape. Skilled artisans will recognize that the handle may have alternative shapes, such as a Y-shape or T-shape among others.

In the invention, the handle includes a holdback at the far end of each prong. The diameters of the prongs are less than the interior diameters of the slide tubes so that the prongs can insert into and slide through the slide tubes. The diameters of the holdbacks are larger than the interior diameters of the slide tubes so that the holdbacks prevent the handle from fully disengaging from the cover support when the cover is in the closed position.

Some preferred embodiments of the invention include two reinforcing braces (a first reinforcing brace and a second reinforcing brace). Each reinforcing brace attaches the adjacent slide tube to the adjacent arm of the cover support. Depending upon the strength of the materials used to construct the invention, these reinforcing braces may not be necessary. The reinforcing braces may have a variety of configurations. For example, the braces may be simple crosspieces, angle brackets, connecting plates, or other structural plates or brackets.

Preferably, embodiments of the invention include a means of sealing any gaps between the cover and the vehicle so that environmental conditions are excluded or mostly excluded from entering through the overhead opening in the vehicle when the cover is closed. Multiple means of scaling such gaps are known in the arts. Preferred embodiments of the invention include an angle bracket coupled to a first sealing gasket along the front edge of the bottom of the cover and a second sealing gasket along the back edge of the bottom of the cover.

The invention also provides kits for a retractable roof system. Kits of the invention include a cover, a frame, two buttresses, a cover support, a handle, and fasteners to attach the retractable roof system to a vehicle. The cover, frame, two buttresses, cover support, and handle are as described above. Suitable fasteners are known in the art. Preferred fasteners include screws, nuts and bolts, and wingnuts of various sizes. Those of skill in the art will appreciate that some types of fasteners will be better suited for coupling a roof system of the invention to different types of vehicles.

Preferably, kits include two reinforcing braces that attaches the adjacent slide tube to the adjacent arm of the cover support. Kits of the invention also include an angle bracket and a first scaling gasket that extends along the front edge of the bottom of the cover and a second sealing gasket that extends along the back edge of the bottom of the cover. Another angle bracket may assist in coupling the second sealing gasket to the bottom of the cover.

Preferably, covers included in a kit are transparent, opaque, or a combination thereof.

The invention also provides methods for assembling a retractable roof system for a vehicle comprising positioning a hardtop cover over an occupant space of the vehicle so that in a closed position the cover is configured to at least partially shield the occupant space from ambient environmental conditions, and the cover is configured to be moved between the closed position and an open position over the occupant space.

The methods of assembly of the invention further provide for coupling a frame that attaches to the vehicle over the occupant space and also attaches to and is configured to support the cover. The frame comprises a front, a back, and two sides, and each side of the frame is coupled to the cover by a buttress (i.e. a first buttress and a second buttress). Each buttress comprises at least one extension that is coupled to the adjacent side of the frame and a horizontal member that is coupled to the bottom of the cover. Preferred buttresses include two or more extensions. Buttresses are attached to the cover by any suitable means such as an adhesive or fasteners such as screws or nuts and bolts. Attached to the frame is a handle that allows an occupant in the vehicle to use one hand to move the installed cover between the closed and open positions. The handle is also coupled to a cover support that is attached to the back of the frame by a mounting bracket.

The mounting bracket has a front section having a first end from which extends a first side section that is coupled to the vehicle and to the cover support and a second end from which extends a second side section that is also coupled to the vehicle and to the cover support. The cover support comprises a rotatable rod, two arms, and two slide tubes. Each end of the rotatable rod is coupled at or near the top of the adjacent arm, and each slide tube is attached at or near the base of the adjacent arm. The handle has a base, a first prong that extends from a first end of the base and has a holdback at its far end, and a second prong that extends from a second end of the base and has a holdback at its far end. The first and second prongs insert through the slide tubes, and the diameters of the holdbacks are larger than the interior diameters of the slide tubes.

The invention also provides methods of using a retractable roof system that comprise (a) operating a handle forward and up to move a cover having a top, a bottom, a front, a back, and two lateral sides, and positioned over an occupant space of a vehicle wherein the handle has a base, a prong extending from each end of the base, and a holdback at the far end of each prong, and the handle is coupled to a cover support that comprises a rotatable rod, two arms, and two slide tubes, wherein each slide tube is attached near or at the base of the adjacent arm of the cover support, each end of the rotatable rod is attached near or at the top of the adjacent arm, and the rotatable rod is in contact with the bottom of the cover, wherein operating the handle causes the cover to move from a closed position to an open position; (b) releasing the handle and allowing the prongs of the handle to slide through the slide tubes so that the base of the handle contacts or is adjacent to the slide tubes; (c) moving the handle upward so that the holdbacks contact the slide tubes; (d) operating the handle down and backward to move the cover from the open position to the closed position; and (c) releasing the handle and allowing the prongs of the handle to slide through the slide tubes so that the holdbacks are in contact with the slide tubes.

Preferably, the invention is installed in an open-sided vehicle such as an ATV, golf cart, or other utility vehicle. Those of skill in the art will appreciate that the invention may be installed in other types of vehicles. It is only necessary that the invention can be attached to the vehicle as intended and operated by an occupant inside the vehicle. Advantageously, operation of the invention may be done with one hand and does not require an external power source.

Other objects, features, and advantages of the present invention will become apparent from the following detailed description. It should be understood, however, that the detailed description and any specific examples, while indicating preferred embodiments of the invention, are given by way of illustration only, since various changes and modifications within the spirit and scope of the invention will become apparent to those skilled in the art from this detailed description. Further, while specific advantages of the invention are detailed herein, various embodiments may include some, none, or all of these enumerated advantages.

### BRIEF DESCRIPTION OF DRAWINGS

The following drawings form part of the present specification and are included to further demonstrate certain aspects of the invention. The invention may be better understood by reference to one or more of these drawings in combination with the detailed description presented herein. All objects and features shown in broken lines are for illustrative purposes only and form no part of the claimed invention. Unless specifically noted, articles depicted in the drawings are not necessarily drawn to scale.

FIG. 1 is an exterior perspective view from above with the roof in the closed position. Broken lines indicate a portion of the vehicle to which the invention is attached.

FIG. 2 is an exterior perspective view from above with the roof in the open position. Broken lines indicate a portion of the vehicle to which the invention is attached.

FIG. 3 is an interior perspective view from below with the roof in the closed position. Broken lines indicate a portion of the vehicle to which the invention is attached.

FIG. 4 is a perspective view from above of the invention without a roof in a partially open or closed position.

FIG. 5 is a perspective view of the invention without a roof in an open position.

FIG. 6 is a side view of the invention in the closed position. Broken lines indicate a portion of the vehicle.

FIG. 7 is a side view of the invention in a partially open position with the handle in an active position. Arrows indicate the direction of the handle's movement. Broken lines indicate a portion of the vehicle.

FIG. 8 is a side view of the invention in the fully open position with the handle in an active position. Broken lines indicate a portion of the vehicle.

FIG. 9 is a side view the invention in the fully open position with the handle in the stored position. Broken lines indicate a portion of the vehicle.

### DETAILED DESCRIPTION

The invention provides a retractable roof system for vehicles that have an occupant space for one or more individuals. Advantageously, retractable roof systems of the invention can be moved between an open position and a closed position with one hand. Operating the invention only requires a few pounds of pressure and is easily operated by an individual seated in the vehicle. No external or additional power source is required to operate systems of the invention.

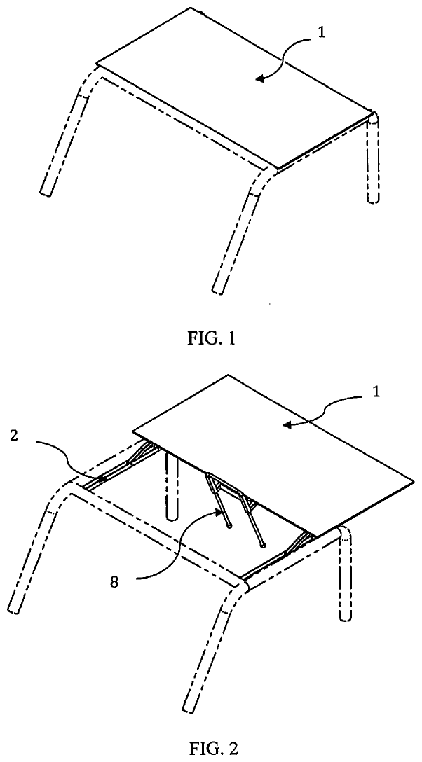

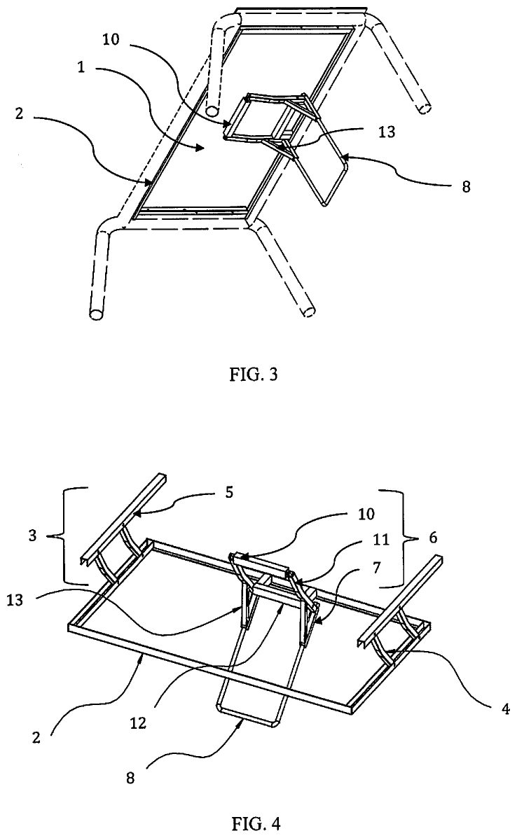

The invention includes a cover 1 that has a top, a bottom, a front, a back, and two lateral sides that is positioned over the occupant space of a vehicle. See FIGS. 1-3. The cover 1 is coupled to a vehicle by a frame 2 that has a front, a back, and two sides. The frame 2 is coupled to the vehicle by using any of a variety of suitable fasteners 14. Suitable fasteners include screws, bolts, washers, nuts, or others that are known in the art.

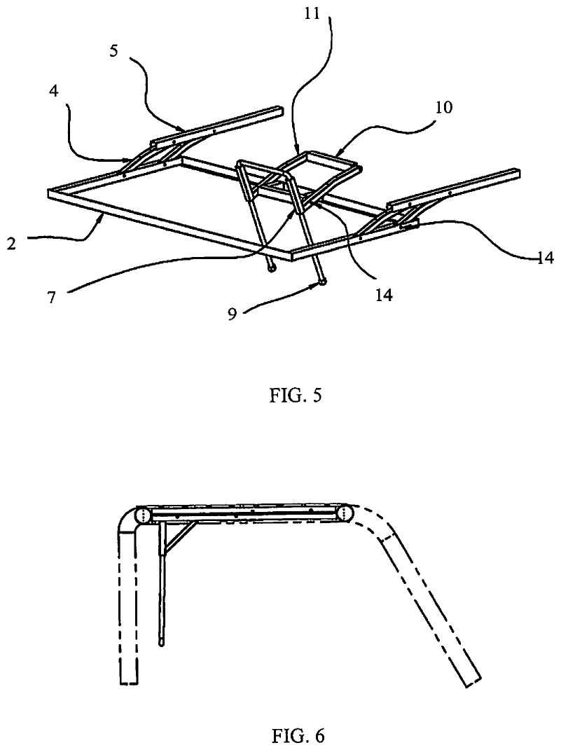

The cover 1 is coupled to the frame 2 by two buttresses 3. See FIGS. 4 and 5. Each buttress 3 has at least one extension 4 and a horizontal member 5. Preferably, each buttress 3 has two extensions 4. In some embodiments, each buttress has three or even four extensions. The number of extensions that are present depends upon the weight and size of the cover 1 and the relative strengths and lengths of the extensions, as well as the overall strength of the retractable cover system.

The first end of each extension 4 is coupled to the adjacent side of the frame 2 by at least one fastener 14 so that the extension can move (i.e. rotate or move up and down) as the retractable roof is moved between the open and closed positions. The second end of each extension 4 is coupled to the adjacent horizontal member 5 by at least one fastener 14 so that the extension can move. Each horizontal member 5 is coupled to the bottom of the cover 1. Horizontal members 5 can be attached to the cover 1 by a variety of suitable means that are known such as adhesives, fasteners, or combinations thereof.

Attached to the back of the frame 2 is a mounting bracket 12. The mounting bracket 12 has a front section and two side sections. Each side section extends from the adjacent end (or area) of the front section of the mounting bracket 12. The side sections are coupled to the vehicle and a cover support 6 by one or more fasteners 14. Preferably, mounting brackets are made of steel or a similarly strong material. Those of skill in the art will recognize that the mounting bracket 12 can have a variety of configurations that will work well in the invention. It is only necessary that the mounting bracket 12 can be coupled to the frame 2 and to the cover support 6 such that the invention can operate as intended.

The cover support 6 comprises a rotatable rod 10, two arms 11, and two slide tubes 7. Preferably, each end of the rotatable rod 10 is attached near or at the top of the adjacent arm 11, and each slide tube 7 is attached near or at the base of the adjacent arm 11. Those of skill in the art will recognize that different configurations of the cover support 6 can be used in the invention and still achieve a retractable roof system. Herein, is described a preferred configuration for a cover support that has been found to function well in the invention.

Coupled to the cover support 6 is a handle 8 that is used to move the retractable roof between the open and closed positions. The handle 8 has a base and two prongs. Each prong extends from the adjacent end of the base of the handle 8, and each prong has a holdback 9 at its far end. The prongs of the handle insert through the slide tubes 7, and the diameters of the holdbacks 9 are larger than the interior diameters of the slide tubes 7 so that the handle 8 is not uncoupled from the cover support 6.

The retractable roof system further comprises two reinforcing braces 13. Each reinforcing brace 13 attaches the adjacent slide tube 7 to the adjacent arm 11 of the cover support 6. Those of skill in the art will appreciate that certain embodiments of the invention will not necessarily include a reinforcing brace 13.

Preferred embodiments of the invention include gaskets that are attached to the bottom of the cover 1 so that when the roof system is closed, the exterior environment (e.g. drafts, rain, dust, etc.) is mostly excluded from the occupant space within the vehicle. In particular, the retractable roof system includes an angle bracket 15 to which a first sealing gasket 16 is coupled along or near the front edge of the bottom of the cover 1, and a second sealing gasket 16 is coupled along or near the back edge of the bottom of the cover 1. The second sealing bracket 16 may be coupled directly to the bottom of the cover 1 or a second angle bracket 15 may be used to attach the second bracket to the cover 1.

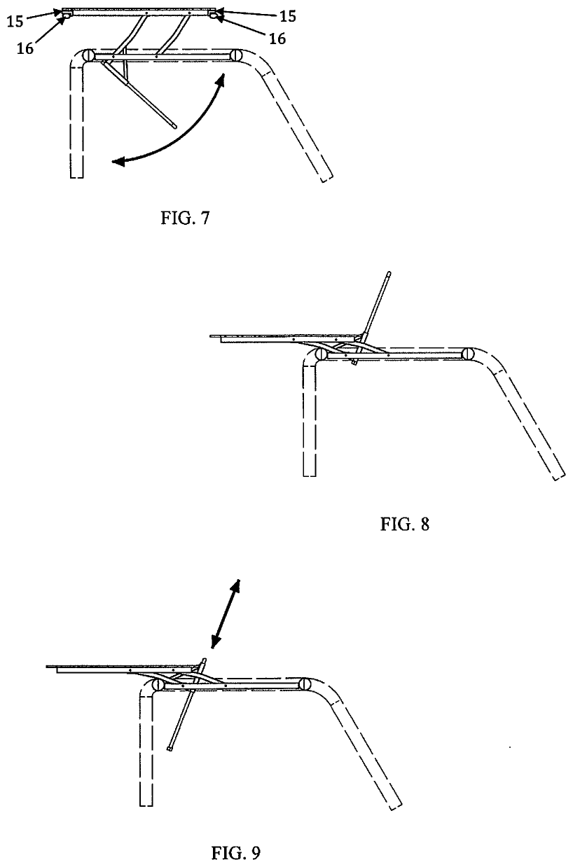

Retractable roof systems of the invention are moved between the opened and closed positions by operating the handle 8 forward and up to move the cover 1 from a closed position to an open position. See FIGS. 6-9. The user then releases the handle 8 and allows the prongs of the handle 8 to slide downward through the slide tubes 7 so that the base of the handle 8 contacts or is adjacent to the slide tubes 7. To move the cover 1 from the opened position to the closed position, the user moves the handle 8 upward so that the holdbacks 9 contact the slide tubes 7. The user then moves the handle 8 down and backward so that the cover 1 moves from the open position to the closed position. The user releases the handle 7, and the holdbacks continue to keep the handle 7 coupled to the cover support 6.

When a retractable roof is moved from one position to another the position of the rotatable rod 10 adjusts (i.e. rotates) so that the cover 1 moves relatively smoothly from one position to another with little effort by the operator.

Skilled artisans will recognize that a variety of suitable materials can be used to make the retractable roof systems of the invention. Preferred embodiments of the invention include a steel frame 2, and a cover 1 that is made from polycarbonates such as LEXAN®, a similar thermoplastic material, or another relatively lightweight, durable material. Preferably, the cover is clear or semi-transparent. While the thickness of a cover can be varied, a thickness of only ¼ inch has been found to work well in roofing systems of the invention without adversely affecting the weight distribution of a system on a vehicle.

The inventor has found that hollow, square steel tubing of approximately ½ inch in diameter works well in the invention for various parts. Alternatively, other materials such as aluminum may be used.

Advantageously, retractable roof systems of the invention can be securely installed to a vehicle with as few as five fasteners.

Unless defined otherwise, all technical and scientific terms used herein have the same meaning as is commonly understood by one of skill in the art to which this invention belongs at the time of filing. Terminology used herein is for the purpose of describing particular embodiments of the invention and is not intended to be limiting. The meaning and scope of terms should be clear; however, in the event of any latent ambiguity, definitions provided herein take precedent over any dictionary or extrinsic definition. Further, unless otherwise required by context, singular terms shall include pluralities and plural terms shall include the singular unless the content clearly dictates otherwise. Herein, the use of “or” means “and/or” unless stated otherwise. As used herein, “each” refers to each member of a set or each member of a subset of a set.

What is claimed is:

1. A retractable roof system comprising
a. a vehicle having an occupant space for one or more individuals;
b. a cover having a top, a bottom, a front, a back, and two lateral sides, wherein the cover is positioned over the occupant space and is configured to be moved between an open position and a closed position over the occupant space;
c. a frame having a front, a back, and two sides that is coupled to the vehicle;
d. a first buttress and a second buttress, wherein each buttress comprises at least one extension and a horizontal member, wherein a first end of each extension is coupled to the adjacent side of the frame and a second end of each extension is coupled to the adjacent horizontal member, and each horizontal member is coupled to the bottom of the cover;
e. a cover support comprising a rotatable rod, two arms, and two slide tubes, wherein each end of the rotatable rod is attached near or at the top of the adjacent arm and each slide tube is attached near or at the base of the adjacent arm;
f. a mounting bracket having a front section and two side sections, wherein each side section extends from the adjacent end of the front section and is coupled to the cover support, and the mounting bracket is coupled to the vehicle either by the front section or by the two side sections; and
g. a handle having a base and two prongs, wherein each prong extends from the adjacent end of the base of the handle and each prong has a holdback at its far end, wherein the prongs insert through the slide tubes, and the diameters of the holdbacks are larger than the interior diameters of the slide tubes.

2. The retractable roof system of claim 1 further comprising two reinforcing braces, wherein each reinforcing brace attaches the adjacent slide tube to the adjacent arm of the cover support.

3. The retractable roof system of claim 1, wherein an angle bracket and a first sealing gasket extend along the front edge of the bottom of the cover and a second sealing gasket extends along the back edge of the bottom of the cover.

4. The retractable roof system of claim 1, wherein the first buttress and second buttress have two or more extensions.

5. The retractable roof system of claim 1, wherein the cover is a hardtop that is transparent, opaque, or a combination thereof.

6. The retractable roof system of claim 1, wherein the vehicle is an all-terrain vehicle (ATV), golf cart, or a utility vehicle.

7. A kit for a retractable roof system comprising
a. a hardtop cover having a top, a bottom, a front, a back, and two lateral sides;
b. a frame having a front, a back, and two sides;
c. a first buttress and a second buttress, wherein each buttress comprises at least one extension and a horizontal member, a first end of each extension is coupled to the adjacent side of the frame, a second end of each extension is coupled to the adjacent horizontal member, and each horizontal member is coupled to the bottom of the cover;
d. a cover support having a rotatable rod, two arms, and two slide tubes, wherein each slide tube is attached to the base of the adjacent cover support arm;
e. a mounting bracket having a front section and two side sections, wherein each side section extends from the adjacent end of the front section and is coupled to the cover support; and
f. a handle having a base and two prongs, wherein each prong extends from one end of the base and has a holdback at its far end, wherein the prongs of the handle insert through the slide tubes, and the diameters of the holdbacks are larger than the interior diameters of the slide tubes.

8. The kit for a retractable roof system of claim 7 further comprising two reinforcing braces, wherein each reinforcing brace attaches the adjacent slide tube to the adjacent arm of the cover support.

9. The kit for a retractable roof system f claim 7, wherein an angle bracket and a first sealing gasket extend along the front edge of the bottom of the cover and a second sealing gasket extends along the back edge of the bottom of the cover.

10. The kit for a retractable roof system of claim 7, wherein the first buttress and second buttress each have two extensions.

11. The kit for a retractable roof system of claim 7, wherein the cover is transparent, opaque, or a combination thereof.

12. A method for assembling a retractable roof system for a vehicle comprising
a. positioning a hardtop cover over an occupant space of the vehicle so that in a closed position the cover is configured to at least partially shield the occupant space from ambient environmental conditions, and the cover is configured to be moved between the closed position and an open position over the occupant space; and
b. coupling a frame that attaches to and is configured to support the cover to the vehicle over the occupant space, wherein the frame comprises a front, a back, and two sides, and each side of the frame is coupled to the cover by a buttress that comprises at least one extension that is coupled to the adjacent side of the frame and a horizontal member that is coupled to the bottom of the cover, wherein the cover is moved between the closed position and open position by a handle that is linked to a cover support that is attached to the back of the frame by a mounting bracket, wherein the mounting bracket has a front section having first end from which extends a first side section that is coupled to the cover support and a second end from which extends a second side section that is coupled to the cover support, and the mounting bracket is coupled to the vehicle either by the front section or by the first and second side sections, and wherein the cover support comprises a rotatable rod, two arms, and two slide tubes, wherein each end of the rotatable rod is coupled at or near the top of the adjacent arm and each slide tube is attached at or near the base of the adjacent arm, and the handle has a base and a first prong that extends from a first end of the base and has a holdback at its far end, a second prong that extends from a second end of the base and has a holdback at its far end, and the first and second prongs insert through the slide tubes, and the diameters of the holdbacks are larger than the interior diameters of the slide tubes.

13. The method for assembling a retractable roof system for a vehicle of claim 12 further comprising two reinforcing braces, wherein each reinforcing brace attaches the adjacent slide tube to the adjacent arm of the cover support.

14. The method for assembling a retractable roof system for a vehicle of claim 12, wherein an angle bracket and a first sealing gasket extend along the front edge of the bottom of the cover and a second sealing gasket extends along the back edge of the bottom of the cover.

15. The method for assembling a retractable roof system for a vehicle of claim 12 wherein the first buttress and second buttress each have two extensions.

16. The method for assembling a retractable roof system for a vehicle of claim 12 wherein the cover is opaque, transparent, or a combination thereof.

17. A method of using a retractable roof system comprising
a. operating a handle forward and up to move a cover having a top, a bottom, a front, a back, and two lateral sides, positioned over an occupant space of a vehicle wherein the handle has a base, a prong extending from each end of the base, and a holdback at the far end of each prong, and the handle is coupled to a cover support that comprises a rotatable rod, two arms, and two slide tubes, wherein each slide tube is attached near or at the base of the adjacent arm of the cover support, each end of the rotatable rod is attached near or at the top of the adjacent arm, and the rotatable rod is in contact with the bottom of the cover, wherein operating the handle causes the cover to move from a closed position to an open position;
b. releasing the handle and allowing the prongs of the handle to slide through the slide tubes so that the base of the handle contacts or is adjacent to the slide tubes;
c. moving the handle upward so that the holdbacks contact the slide tubes;
d. operating the handle down and backward to move the cover from the open position to the closed position; and
e. releasing the handle and allowing the prongs of the handle to slide through the slide tubes so that the holdbacks are in contact with the slide tubes.

18. The method for using a retractable roof system of claim 17, wherein the diameters of the holdbacks are larger than the interior diameters of the slide tubes.

19. The method for using a retractable roof system of claim 17, wherein
a. a frame that has a front, a back, a first side, and a second side is coupled to the vehicle over the occupant space;
b. a first buttress is coupled to the first side of the frame and a second buttress is coupled to the second side of the frame, wherein each buttress comprises a horizontal member and at least one extension having a first end and a second end, wherein the first end of each extension is coupled to the adjacent side of the frame and the second end of each extension is coupled to the adjacent horizontal member, and each horizontal member is coupled to the bottom of the cover; and
c. a mounting bracket having a front section and two side sections, wherein each side section extends from the adjacent end of the front section is coupled to the cover support, and the mounting bracket is coupled to the vehicle either by the front section or by the two side sections.

20. The method for using a retractable roof system of claim 17, wherein each slide tube is attached to the adjacent arm of the cover support by a reinforcing brace.
